(19) United States
(12) Patent Application Publication
(10) Pub. No.: US 2003/0149118 A1
(43) Pub. Date: Aug. 7, 2003

(54) Method and composition which inhibits the oxidation of omega-3 and omega-6 polyunsaturated lipids

(75) Inventors: Ahmad Akashe, Mundelein, IL (US); Steven E. Hill, Prospect Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/377,474

(22) Filed: Feb. 28, 2003

Related U.S. Application Data
(63) Continuation of application No. 09/675,932, filed on Sep. 29, 2000, now abandoned.

(51) Int. Cl. C09K 3/00

(52) U.S. Cl. 516/56

(57) ABSTRACT

The invention is directed to a method and composition which inhibits the oxidation of omega-3 and omega-6 polyunsaturated lipids in an aqueous emulsion. This invention is especially directed to a method and composition which inhibits the oxidation of long chain omega-3 polyunsaturated lipids in an aqueous emulsion. When soy protein, and in particular, soy protein isolates, are blended with omega-3 and/or omega-6 polyunsaturated lipids, the rate of oxidation of the omega-3 and/or omega-6 lipids is reduced and the shelf life of such lipids is extended.

### FIELD OF THE INVENTION

This invention is directed to a method and composition which inhibits the oxidation of omega-3 and omega-6 polyunsaturated lipids in an aqueous emulsion. When soy protein, and in an important aspect, soy protein isolates, are blended with omega-3 and/or omega-6 polyunsaturated lipids, the rate of oxidation of the omega-3 and/or omega-6 lipids is reduced and the shelf life of such lipids is extended. This invention is especially adapted for increasing the oxidative stability of long chain omega-3 polyunsaturated lipids in aqueous emulsions.

### BACKGROUND OF THE INVENTION

Lipid oxidation is a major cause of food deterioration affecting flavor, aroma, color, texture, and the nutritional value of the particular food. Additionally, free radicals formed during lipid oxidation may participate in the development of arteriosclerosis and other diseases. Long chain omega-3 polyunsaturated fatty acids or lipids such as 5, 8, 11, 14, 17-eicosapentaenoic acid and 4, 7, 10, 13, 16, 19-docosahexaenoic acid (EPA and DHA, respectively) are fatty acids naturally found in fish or marine oil at about a 15 to about 30 percent level, and are known to have a wide range of nutritional and health benefits such as, for example, lowering blood triglycerides in humans and, therefore, lowering the risk and/or incidence of cardiovascular diseases. Other health benefits associated with long chain omega-3 oils include health immunity (anti-arthritis) and mental and visual acuity in developing infants and children. Based on these and other emerging benefits of omega-3 fatty acids, foods containing omega-3 fatty acids can be considered as functional foods. The increase in popularity of such functional foods and nutraceuticals demonstrates that consumer demand for healthful foods is on the rise. Unfortunately, formulating foods with omega-3 lipids is difficult because of their oxidative instability.

Highly unsaturated lipids, such as fats and oils, undergo oxidation. While not intending to be bound by theory, it is believed that the oxidation of these lipids is caused by a free radical chain reaction involving peroxides and the formation of the highly odorous reaction products. It may be that a free radical is formed by an initiator such as ozone or a oxide radical formed from the interaction of contaminants in lipids. Other initiators could include UV radiation and enzymes, such as xanthine oxidase, which produce radicals which ultimately cause the oxidation of the unsaturated lipids.

Fish oils are examples of highly unsaturated oils which may contain as many as six sites of unsaturation and are readily oxidized. This instability helps explain their frequent poor odor and flavor characteristics after a relatively short period of storage time. It is very difficult to produce a fish oil-containing product which has an extended shelf life. As previously noted, however, fish oil contains a large amount of highly unsaturated fatty acids such as eicosapentaenoic acid and docosahexaenoic acid. These fatty acids have been shown to be beneficial in controlling the triglyceride level in blood and in preventing thrombotic disturbances. For harnessing the health and wellness of foods containing omega-3 fatty acids, it is critical for the food developer to protect the nutritional integrity, by preventing the oxidative rancidity of omega-3 fatty lipids.

### SUMMARY OF THE INVENTION

This invention is related to a method for the stabilization of an aqueous emulsion of polyunsaturated omega-3 and/or omega-6 lipids by soy protein, and in and important aspect, by soy protein isolates (SPI). The invention also is related to a composition which is an aqueous emulsion of polyunsaturated omega-3 and/or omega-6 lipids and soy proteins, and in an important aspect, soy protein isolates. Especially preferred polyunsaturated lipids for use in the present invention include the long chain omega-3 polyunsaturated lipids. The invention stabilizes an aqueous emulsion of omega-3 or omega-6 polyunsaturated lipids with the soy protein where the emulsion is at least 8 times more stable than a similar, but not stabilized, emulsion (i.e., without added stabilizer) stored under similar conditions. Indeed, the invention stabilizes an aqueous emulsion of omega-3 and/or omega-6 polyunsaturated lipids with the soy protein where the emulsion of the invention is at least 8 times more stable than an emulsion which includes, for example, Polysorbate 60 (a polyoxyethylene sorbetan oleate) alone as a stabilizer where both emulsions are stored at about the same time and temperature.

Generally, the emulsion of the invention includes at least about 0.1 percent polyunsaturated omega-3 or omega-6 lipids and at least about 0.5 percent soy protein to stabilize the polyunsaturated omega-3 or omega-6 lipids in the emulsion. In an important aspect, the emulsion of the invention comprises from about 0.1 to about 50 percent polyunsaturated omega-3 or omega-6 lipids and from about 0.5 to about 5 percent soy protein.

The invention allows the formulation of excellent food products containing healthful functional ingredients such as a polyunsaturated omega-3 or omega-6 lipid, and especially a oil long chain polyunsaturated omega-3 lipid, with an extended shelf life feasible for commercial applications and consumption. The synergy between the two ingredients, the lipids and soy protein or soy protein isolates, provides an added opportunity for bundling health functional ingredients in the same composition where soy protein and lipids contribute to heart health benefits, but utilize different mechanisms.

### DETAILS OF THE INVENTION

As used herein, “omega-3 lipid” means a lipid in which the first double bond is in the third position from the terminal methyl group. As used herein, “omega-6 lipid” means a lipid in which the first double bond is in the sixth position from the terminal methyl group. The term “lipid” is intended to include both omega-3 and omega-6 lipids. Such term includes, but is not limited to, alpha-linolenic acid, eicosapentaenoic acid and docosahexaenoic acid. “Polyunsaturated lipid” means an oil, fat, fatty acid steroid, and cartenoid with a carbon chain which has at least 8 carbon atoms and which has at least one double bond. The preferred polyunsaturated lipids of this invention are long chain polyunsaturated lipids having at least 18 carbon and three double bonds in the carbon chain. Such long chain polyunsaturated lipids include, but is not limited to, linolenic acid, eicosapentaenoic acid and docosahexaenoic acid. “Soy protein” means vegetable protein from soy. “Soy protein isolate” means a material which has at least 90 percent protein from soy.

The effect of soy protein on stabilizing polyunsaturated omega-3 or omega-6 lipids against oxidation is very significant in aqueous emulsions. This stabilization also slows the process of the omega-3 and omega-6 lipids, especially polyunsaturated omega-3 acids, from going rancid and extends the shelf life of the polyunsaturated lipids when they are a part of an aqueous emulsion. Experiments with fish oil at 10 percent fish oil, which contains 25 percent DHA and EPA, and 2 percent soy protein isolate was found to be about 8 to about 10 times more stable than the same emulsion containing Polysorbate 60 as the only emulsion stabilizer, 3 times more stable than the same emulsion which used whey protein isolate as the only emulsion stabilizer and 2 times more stable than the same emulsion which used egg yolk alone as the only emulsion stabilizer.

According to the invention, the rate of oxidative deteriation of omega-3 or omega-6 polyunsaturated lipids is reduced by blending and emulsifying soy protein into an aqueous emulsion where the soy protein is in an amount effective for slowing the rate of oxidative rancidity of the polyunsaturated lipids in the emulsion. This invention is especially directed at reducing oxidation in omega-3 or omega-6 polyunsaturated lipids such as those found in fish oil, flax seed oil, sea algae, and the like. As noted, the emulsion of the invention generally includes at least about 0.1 percent polyunsaturated lipids and at least about 0.5 percent soy protein to stabilized the lipids in the emulsion. In an important aspect, the emulsion of the invention comprises from about 0.1 to about 50 percent polyunsaturated omega-3 or omega-6 lipids and from about 0.5 to about 5 percent soy protein.

The following examples set forth the method and compositions of the invention and illustrate how to practice the invention; these examples are not intended to limit the invention. Unless otherwise indicated, all percentages are by weight.

### EXAMPLE 1

In this example, an emulsion composition (O/W) was prepared with omega-3 oil from marine sources (menhaden oil) at 25% EPA+DHA. The oil in water emulsion was emulsified with various emulsifiers commonly used in food emulsions, including Polysorbate 60, egg yolk, whey proteins, and soy proteins.

Emulsion Preparation: In a glass beaker with a gentle mixing, the emulsifier is hydrated in water, then the fish oil (liquid at room temperature) is added slowly to form a coarse pre-emulsion. The pre-emulsion then passes twice through a high pressure bench homogenizer (Gaulin) at 3000 psi. The collected emulsion was immediately analyzed for oxidation stability using an OSI (oxidation stability instrument) instrument.

Analysis: 5 g of the prepared emulsion were loaded into a glass vial, and then hermetically sealed with a septum. The sample vial was connected with an oxygen-sparing source. The sample was then loaded into the loading well, which is stirred with a stirring magnet at a constant controlled temperature of 60° C. The instrument measures the oxygen up take (drop in oxygen pressure) by the polyunsaturated fatty acids as function of time. When oxidation takes of, a rapid drop in oxygen pressure is measured.

Results: The following results were obtained.

| | Emulsifier | Fish | OSI |
|---|---|---|---|
| Emulsifier | Amount (%) | Oil (%) | (hours) |
| Polysorbate 60 | 0.25 | 10 | 10 |
| Salted Egg Yolk | 4 | 10 | 45 |
| Whey Protein | 2 | 10 | 38 |
| Isolate | | | |
| Soy Protein Isolate | 2 | 10 | 91 |

The above results clearly demonstrate the longer time needed to completely oxidize the sample with the SPI as compared to the other emulsifiers.

### EXAMPLE 2

This example demonstrates the effect on the stability of a fish oil emulsion by a combination of more than one emulsifier. Using the same procedures as in Example 1, the following results were obtained

| Emulsifier | Fish Oil (%) | OSI (hours) |
|---|---|---|
| 0.25% Polysorbate 60 + | 10 | 63 |
| 4% Egg Yolk | | |
| 0.25% Polysorbate + | 10 | 85 |
| 2% SPI | | |

### EXAMPLE 3

This example demonstrates the effect of soy protein isolate on fish oil in bulk. Straight fish oil at 25% EPA+DHA with and without SPI was loaded into OSI vial and analyzed at 60° C.

| SPI | Fish Oil | OSI (hours) |
|---|---|---|
| 0.02 g | 5.0 g | 124 |
| 0 | 5.0 g | 129 |

The results from this experiment show no effect of the soy proteins on the bulk oil.

### EXAMPLE 4

This example helps show the source of antioxidant activities in the SPI. Soy protein isolate without isoflavones (from ADM) was incorporated into the model emulsion and the compared to SPI with isoflavones used in Example 1.

| SPI Type | Fish Oil | OSI (hours) |
|---|---|---|
| 2% SPI with Isoflavones | 10 | 91 |
| 2% SPI with no isoflavones, | 10 | 47 |
| ProFam 891 | | |
| 0.25% Polysorbate 60 + | 10 | 9 |
| 0.0055% isoflavones | | |
| 2% SPI with no isoflavones | 10 | 57 |
| (ProFam891) + 0.0055% | | |
| isoflavones | | |

The above results indicate that the antioxidant activities are attributed to the naturally complex of soy proteins and isoflavones. Adding extracted isoflavones alone to the emulsion or added extracted isoflavone with no isoflavones soy proteins do not demonstrate the antioxidation effect as it was with naturally comixed soy protein with the isoflavones.

What is claimed is:

1. A method to reduce the rate of oxidation of omega-3 or omega-6 polyunsaturated lipids in an aqueous emulsion, the method comprising blending soy protein into the emulsion in an amount effective for slowing the rate of oxidative rancidity of the omega-3 or omega-6 polyunsaturated lipid in the emulsion.

2. The method as recited in claim 1, wherein the soy protein is in the form of soy protein isolate.

3. The method as recited in claim 1, wherein the aqueous emulsion comprises at least about 0.5 percent soy protein.

4. The method as recited in claim 2, wherein the aqueous emulsion comprises at least about 0.5 percent soy protein isolate.

5. The method as recited in claim 1, wherein the omega-3 or omega-6 lipid is in the form of fish oil, flax seed oil, or sea algae.

6. The method as recited in claim 1, wherein the omega-3 or omega-6 lipid includes a long chain polyunsaturated lipid.

7. The method as recited in claim 6, wherein the long chain polyunsaturated lipid is selected from the group consisting of eicosapentaenoic acid and docosahexaenoic acid.

8. A method to reduce the rate of oxidation of long chain omega-3 polyunsaturated lipids in an aqueous emulsion, the method comprising blending soy protein into the emulsion in an amount effective for reducing the oxidation of the omega-3 polyunsaturated lipids by at least 8 times as compared to an emulsion stored for about the same time and at about the same temperature with the same amount of omega-3 lipids which emulsion does not have an oxidation stabilizer.

9. The method as recited in claim 8, wherein the aqueous emulsion comprises at least about 0.5 percent soy protein isolate.

10. The method as recited in claim 9, wherein the omega-3 lipid is in the form of fish oil, flax seed oil, or sea algae.

11. The method as recited in claim 8, wherein the omega-3 lipid includes a long chain polyunsaturated acid.

12. The method as recited in claim 11, wherein long chain polyunsaturated acid is selected from the group consisting of eicosapentaenoic acid and docosahexaenoic acid.

13. An aqueous emulsion comprising
an omega-3 or omega-6 polyunsaturated lipid; and
at least about 0.5 percent soy protein, the amount of soy protein in the emulsion effective for reducing the oxidation of the omega-3 or omega-6 polyunsaturated lipids by at least 8 times as compared to a control emulsion stored for about the same time and at about the same temperature with the same amount of omega-3 or omega-6 lipids, wherein the control emulsion does not have an oxidation stabilizer.

14. The aqueous emulsion as recited in claim 13, wherein the aqueous emulsion comprises at least about 0.5 percent soy protein.

15. The aqueous emulsion as recited in claim 13, wherein the aqueous emulsion comprises at least about 0.5 percent soy protein isolate.

16. The aqueous emulsion as recited in claim 13, wherein the omega-3 or omega-6 lipid is in the form of fish oil, flax seed oil, or sea algae.

17. The aqueous emulsion as recited in claim 15, wherein the omega-3 or omega-6 lipid includes a long chain polyunsaturated fatty acid.

18. The aqueous emulsion as recited in claim 17, wherein the long chain polyunsaturated fatty acid is selected from the group consisting of eicosapentaenoic acid and docosahexaenoic acid.

19. The aqueous emulsion as recited in claim 13, wherein the aqueous emulsion comprises from about 0.5 to about 5 percent soy protein and at least about 0.1 percent of a omega-3 or omega-6 polyunsaturated lipid.

20. The aqueous emulsion as recited in claim 17, wherein the aqueous emulsion comprises from about 0.5 to about 5 percent soy protein and at least about 0.1 percent of a omega-3 or omega-6 polyunsaturated lipid.
